(19) United States
(12) Patent Application Publication
(10) Pub. No.: US 2023/0321951 A1
(43) Pub. Date: Oct. 12, 2023

(54) MULTILAYER UNIMATERIALS AND RELATED ARTICLES

(71) Applicant: BOARD OF TRUSTEES OF MICHIGAN STATE UNIVERSITY, East Lansing, MI (US)

(72) Inventors: Muhammad Rabnawaz, East Lansing, MI (US); Mohamed Ahmed Abdelwahab, East Lansing, MI (US)

(21) Appl. No.: 18/133,113

(22) Filed: Apr. 11, 2023

Related U.S. Application Data
(60) Provisional application No. 63/330,139, filed on Apr. 12, 2022.

(51) Int. Cl. B32B 7/027; B32B 27/08; B32B 27/36; B32B 27/32

(52) U.S. Cl. CPC B32B 7/027; B32B 27/08; B32B 27/36; B32B 27/32; B32B 2307/7242; B32B 2307/7376; B32B 2307/30; B32B 2307/31; B32B 2305/70; B32B 2250/03; B32B 2439/70

(57) ABSTRACT

The disclosure relates to multilayer laminate compositions including opposing first and second polymeric layers, typically with an intervening gas and/or moisture barrier layer. The first polymeric layer incudes a first polymer, which can be selected based on desired mechanical and/or chemical properties. The second polymeric layer is a heat-sealable analog of the first polymeric layer, and it can include a blend of the first polymer along with a second polymer having a lower melting temperature, or a second polymer that includes monomer units of the first polymer copolymerized with a second monomer to provide a lower melting temperature for the second polymer relative to the first polymer. The improved heat-sealing properties of the second polymeric layer permits convenient packaging of items, and the common polymeric components between the first and second polymeric layers facilitates recycling and reuse of the multilayer laminate composition because of its substantially unimaterial nature.

### CROSS REFERENCE TO RELATED APPLICATION

Priority is claimed to U.S. Provisional Application No. 63/330,139 filed on Apr. 12, 2022, which is incorporated herein by reference in its entirety.

### STATEMENT OF GOVERNMENT INTEREST

None.

### BACKGROUND OF THE DISCLOSURE

### Field of the Disclosure

The disclosure relates to multilayer laminate compositions including opposing first and second polymeric layers, optionally with an intervening gas and moisture barrier layer. The second polymeric layer is a heat-sealable analog of the first polymeric layer, including a blended polymer or an copolymerized comonomer to provide a lower melting temperature of the second polymeric layer relative to the first polymeric layer. The multilayer laminate composition can be used in packaging applications and is amenable to recycling and reuse due to its substantially unimaterial nature.

### Brief Description of Related Technology

Due to their adaptability and affordability, over 100 million tons/year of flexible and rigid multilayer plastics (MLPs) are produced worldwide. Therefore, MLPs account for more than 30% of all plastics produced. However, MLPs possess complex structures that are comprised of multiple layers of various materials to acquire different functions. This complexity has obstructed the development of End of Life (EoL) solutions for MLPs. For example, various components such as metalized films, nylons, PET, tie layers (adhesive layers) each possess different chemical reactivity, poor miscibility, and varying melt-processability that impedes efforts to mechanically recycle MLPs. Furthermore, metalized films are even more challenging to melt-reprocess as metal melts at very high temperatures at which the plastic components decompose entirely (though metalized films can be downcycled into composites where the metal becomes a filler but can wear the processing equipment).

The chemical recycling of MLPs (e.g., pyrolysis, catalytic cracking, gasification, and depolymerization) is also extremely challenging due to the generation of harmful byproducts, such as nitriles and hydrogen cyanide from nylon-bearing MLPs, while catalyst poisoning during catalytic cracking presents another issue. Furthermore, 10-15% of MLPs never fulfill their designated final packaging applications due to the need for templated trimming, and they are thus a leading contributor to post-industrial waste due to their poor recyclability.

One approach that is gaining popularity is the utilization of a unimaterial concept including several polyethylenes of varying branching degrees, to preserve the improved multilayer properties while generating a material that is directly recyclable. The commercial RETAIN polymer modifier acts as a compatibilizer for polyethylene vinyl alcohol (EVOH) and polyethylene, and is added as tie layer between polyethylene and EVOH layers. However, all-polyethylene MLPs have lower mechanical and thermal properties than those of the nylon-based MLPs. The lack of good optical properties is among the other challenges associated with all-polyethylene MLPs. Vitrimer chemistry (thermally reversibly crosslinked materials) can be used to improve the mechanical properties of all-polyethylene MLPs, but achieving control over the rheology and the crosslinking degree of vitrimers is still highly challenging. All-polyethylene MLPs are also challenging to recycle. For example, it is challenging to recycle all-polyethylene MLPs at their EoL, because such MLPs generally include EVOH and/nylon components, which exhibit poor compatibility with polyethylene when they are melt-blended. To mitigate this issue, one needs to add costly compatibilizers, which limit the economic viability of this approach. The only current EoL outcome for the all-polyethylene MLPs is their pyrolysis/cracking/gasification into fuels of very little value rather than recovering the monomer. Therefore, such all-polyethylene MLPs are less likely to offer any significant advantage over the existing non-recyclable MLPs.

### SUMMARY

In one aspect, the disclosure relates to a multilayer laminate composition comprising: a first (thermoplastic polymeric) layer comprising a first polymer; and a heat-sealable second (thermoplastic polymeric) layer adjacent to the first layer and comprising (i) the first polymer in an amount of 80-98 wt. % (or 90-98, 93-97, or 95-97 wt. %) relative to the second layer and (ii) a second polymer (e.g., different from the first polymer) in an amount of 2-20 wt. % (or 2-10, 3-7, or 3-5 wt. %) relative to the second layer; and optionally, a (gas and/or moisture) barrier layer interposed between the first layer and the second layer; wherein: the second polymer has a lower melting temperature (Tₘ) than that of the first polymer; optionally, the first polymer and the second polymer are present in an amount of at least 95 wt. % (or 98 wt. % or 99 wt. %) relative to the second layer; and optionally, the first polymer is present in an amount of at least 95 wt. % (or 98 wt. % or 99 wt. %) relative to the first layer.

In a refinement, the first polymer is present in the multilayer laminate composition (e.g., combined amount in first and second layers) in an amount of at least 90 wt. % (e.g., at least 90, 92, 95, 98, or 99 wt. % and/or up to 95, 98, 99, 99.5 wt. %) relative to the multilayer laminate composition (e.g., combined weight of first layer, second layer, and barrier layer when present).

In a refinement, the first polymer and the second polymer are independently selected from the group consisting of polyesters, polyolefins, and polyamides. Suitably, the first and second polymers are selected within the same class/type of polymer (e.g., both polyesters, both polyolefins, both polyamides, etc.). The polyolefins can include polypropylene homo- and co-polymers, polyethylene of various densities and homo- and co-polymers, etc. The polyesters can include polyethylene terephthalate, polyethylene adipate, polyethylene succinate, polybutylene terephthalate, polybutylene adipate, polybutylene succinate, polycaprolactone, polyhdyroxyalkanoates, and polylactic acid. Polyesters can also be chosen where some on-demand cleavable groups are incorporated such as intermittent carbon-carbon double bonds, intermittent ether linkages, acetal linkages, and so on. In some embodiments, the first and second polymers can be the same type of polymer, but with different melting temperatures (e.g., due to different molecular weights) such that the second polymer still has a lower melting temperature than that of the first polymer to improve heat sealing properties of the second layer. For example, the first and second polymers can both be PET polyesters, with the second PET having a lower melting temperature (e.g., also a lower number-, weight-, or volume-average molecular weight) than the first PET.

In a refinement, the first polymer and the second polymer are selected from the following combinations: (i) the first polymer is polyethylene terephthalate (PET), and the second polymer is a polyester other than polyethylene terephthalate; (ii) the first polymer is a first polyethylene terephthalate (PET), and the second a second polyethylene terephthalate (PET) having a lower melting temperature (Tₘ) than that of the first PET (e.g., second PET having a lower molecular weight than the first PET); (iii) the first polymer is polylactic acid (PLA), and the second polymer is a polyester other than polylactic acid; (iv) the first polymer is high density polyethylene (HDPE), and the second polymer is low-density polyethylene (LDPE) or linear low-density polyethylene (LLDPE); and (v) the first polymer is polypropylene (PP), and the second polymer is low-density polyethylene (LDPE) or linear low-density polyethylene (LLDPE).

In one aspect, the disclosure relates to a multilayer laminate composition comprising: a first (thermoplastic polymeric) layer comprising a first polymer comprising one or more first monomer units; and a heat-sealable second (thermoplastic polymeric) layer adjacent to the first layer and comprising a second polymer comprising (i) the one or more first monomer units in an amount of 80-98 wt. % (or 90-98, 93-97, or 95-97 wt. %) relative to the polymer and (ii) second monomer units (different from the one or more first monomer units) in an amount of 2-20 wt. % (or 2-10, 3-7, or 3-5 wt. %) relative to the second polymer; and optionally, a (gas and/or moisture) barrier layer interposed between the first layer and the second layer; wherein: the second polymer has a lower melting temperature (Tₘ) than that of the first polymer; optionally, the second polymer is present in an amount of at least 95 wt. % (or 98 wt. % or 99 wt. %) relative to the second layer; and optionally, the first polymer is present in an amount of at least 95 wt. % (or 98 wt. % or 99 wt. %) relative to the first layer.

In a refinement, the one or more first monomer units are present in the multilayer laminate composition (e.g., combined amount in first and second layers among polymers therein) in an amount of at least 90 wt. % (e.g., at least 90, 92, 95, 98, or 99 wt. % and/or up to 95, 98, 99, 99.5 wt. %) relative to the multilayer laminate composition (e.g., combined weight of first layer, second layer, and barrier layer when present).

In a refinement, the first polymer and the second polymer are independently selected from the group consisting of polyesters (e.g., polyethylene terephthalate), polyolefins, and polyamides. Suitably, the first and second polymers are selected within the same class/type of polymer (e.g., both polyesters, both polyolefins, both polyamides, etc.). Examples of specific polymers and polymer classes are as described above.

In a refinement, the first polymer and the second polymer are selected from the following combinations: (i) the one or more first monomer units comprise terephthalic acid/terephthalic ester and ethylene glycol (e.g., PET first polymer based on diacid or diester terephthalic units), and the second monomer units comprise at least one diacid/diester different from terephthalic acid/terephthalic ester (e.g., PET-based second copolymer); and/or (ii) the one or more first monomer units comprise terephthalic acid/terephthalic ester and ethylene glycol (e.g., PET first polymer based on diacid or diester terephthalic units), and the second monomer units comprise at least one diol different from ethylene glycol (e.g., PET-based second copolymer) and/or or one diacid/diester different form terephthalic acid/terephthalate.

Various refinements of the disclosed multilayer laminate compositions in any of their aspects are possible.

In a refinement, the first polymer has a first melting temperature (T_{m,1}) of at least 100° C. or 130° C. (at least 100, 130, 150, 180, 200, 220, or 250° C. and/or up to 175, 200, 225, 250, 270, 300° C.); and/or the second polymer has a second melting temperature (T_{m,2}) of up to 225° C. (at least 50, 100, 120, 150, 180, or 200° C. and/or up to 100, 120, 140, 160, 175, 200, 225° C.).

In a refinement, the first polymer has a first melting temperature (T_{m,1}); the second polymer has a second melting temperature (T_{m,2}); and a temperature difference (T_{m,1}−T_{m,2}) is at least 10° C., for example at least 10, 15, 20, 25, 30, 40, 50, 70, or 100° C. and/or up to 20, 30, 40, 50, 60, 70, 80, 100, 120, 150, or 200° C. In some further refinements, (i) the first polymer is polyethylene terephthalate, and (ii) the temperature difference (T_{m,1}−T_{m,2}) is in a range of 30-80° C. In some further refinements, (i) the first polymer is a polyolefin, and (ii) the temperature difference (T_{m,1}−T_{m,2}) is in a range of 10-40° C. or 10-60° C.

In a refinement, the first layer has a thickness in a range of 5 μm to 1000 μm (at least 5, 10, 20, 30, 40, 50, 60, 80, 100, or 200 μm and/or up to 15, 25, 50, 75, 100, 200, 300, 500, or 1000 μm); the second layer has a thickness in a range of 0.5 μm to 100 μm (at least 0.5, 1, 2, 3, 4, 5, 6, 8, 10, or 20 μm and/or up to 1.5, 2.5, 5, 7.5, 10, 15, 20, 30, 50, or 100 μm); and/or a ratio of the first layer thickness:the second layer thickness is in a range of 1:1 to 100:1 (at least 1:1, 2:1, 3:1, 4:1, 5:1, 6:1, 8:1, 10:1, or 20:1 and/or up to 2:1, 5:1, 10:1, 20:1, 30:1, 40:1, 50:1, or 100:1).

In a refinement, the second polymer is preferentially or at least partially co-crystallizable with the first polymer (e.g., exhibiting isodimorphic crystallization and/or isomorphism with the first polymer).

In a refinement, the barrier layer is absent, for example with the first layer being in direct contact with the second layer.

In a refinement, the barrier layer is present, for example with the barrier layer being in direct contact with the first layer and the second layer on opposing sides of the barrier layer. In some further refinements, the barrier layer comprises a material selected from the group consisting of inorganic oxides (e.g., silicon oxide (SiOx) or silicon dioxide/silica (SiO₂), or alumina (Al₂O₃)), and organic materials (e.g., liquid crystalline polymers, polyglycolic acid, melamine, and reversibly or irreversibly crosslinked polymers (e.g., a complex of polyacrylic acid-polyethylene imine ionic network)), either with and without fillers such as modified or unmodified nanoclay, modified or unmodified cellulose nanocrystals, modified or unmodified cellulose nanofilament, and modified or unmodified graphene oxides. In some further refinements, the barrier layer is a non-metallic gas and/or moisture barrier layer (e.g., having low water- and/or oxygen-permeability; such as without metals in metallic or alloyed form, but possibly in various inorganic oxides, etc.). In some further refinements, the barrier layer has a thickness in a range of 5 nm to 5000 nm, for example at least 5, 10, 20, 30, 40, 50, 60, 80, 100, or 200 nm and/or up to 15, 25, 50, 75, 100, 150, 200, 300, 500, 1000, or 5000 nm.

In a refinement, a heat seal strength between two surfaces of the heat-sealable second layer is at least 5 MPa, for example at least 5, 10, 15, 20, or 30 MPa and/or up to 10, 20, 30, 40, 50, or 60 MPa. This can represent two separate surfaces from the same or different multilayer laminate composition that are heat-sealed together.

In a refinement, the multilayer laminate composition has a recycled polymer content in a range of 0-100 wt. % or 10-50 wt. % relative to total polymer content in the multilayer laminate composition, for example at least 5, 10, 20, 30, 40, 60, or 80 wt. % and/or up to 20, 30, 50, 70, 85, 95, or 100 wt. %.

In a refinement, the first polymer and the second polymer are polyesters that are chemically and mechanically recyclable, compostable, and biodegradable in soil and/or water (e.g., saltwater and/or fresh water).

In another aspect, the disclosure relates to a packaged article comprising: a packaged item; and at least one multilayer laminate composition of any of the variously disclosed aspects, refinements, embodiments, etc.; wherein: the at least one multilayer laminate composition at least partially encloses (or completely encloses) the packaged item; and the heat-sealable second layer of the multilayer laminate composition is heat-sealed to a further heat-sealable second layer (e.g., on the same or different multilayer laminate composition). Enclosure of the packaged item can provide gas and/or moisture exposure protection to the packaged items based on the multilayer laminate composition's gas and moisture barrier properties. In some embodiments, multiple multilayer laminate composition sheets can be positioned such that their second layers are at least partially in contact for subsequent heat sealing, and other portions of the second layers are facing or in contact with the packaged item. In some embodiments, a single multilayer laminate composition sheet can be wrapped or folded around the packaged item and then heat sealed to itself (i.e., at two different regions of the second layer) to enclose the packaged item. The packaged item is not particularly limited and can include a food item such as dairy, cheese, fruits, vegetables, nuts, meat (e.g., beef, pork, chicken, or fish), etc. The packaged item also can be a non-food item such as a pharmaceutical composition, etc.

In another aspect, the disclosure relates to a method for forming a packaged article, the method comprising: enclosing a packaged item with at least one multilayer laminate composition of any of the variously disclosed aspects, refinements, embodiments, etc., and the heat sealing at least two second layers of the multilayer laminate composition(s) to form the packaged article.

In another aspect, the disclosure relates to a method of recycling a polymer, the method comprising: performing a mechanical recycling process or a chemical (depolymerization) recycling process on multilayer laminate composition of any of the variously disclosed aspects, refinements, embodiments, etc., thereby recovering and forming recycled first polymer (e.g., in a blend with the second polymer in a mechanical recycling process) or recycled monomers of the first polymer (e.g., in a chemical depolymerization recycling process). Mechanical recycling (e.g., melt reprocessing of thermoplastics) and chemical recycling (e.g., depolymerization to recover monomers) processes are generally known in the art. The multilayer laminate compositions according to the disclosure are particularly suited for mechanical and chemical recycling processes, because they can be recycled in essentially their form as originally manufactured (e.g., post-industrial) or their form after use (e.g., post-consumer), given their unimaterial nature in which the composition is substantially all first polymer, which in turn means that the composition does not contain substantial impurities interfering with the recycling process. Accordingly, there is no need to sort or separate the first and second layers from each other, remove the gas and/or moisture barrier layer when present, etc. before recycling.

While the disclosed articles, apparatus, methods, and compositions are susceptible of embodiments in various forms, specific embodiments of the disclosure are illustrated (and will hereafter be described) with the understanding that the disclosure is intended to be illustrative, and is not intended to limit the claims to the specific embodiments described and illustrated herein.

### BRIEF DESCRIPTION OF THE DRAWINGS

For a more complete understanding of the disclosure, reference should be made to the following detailed description and accompanying drawings wherein:

FIG. 1 is a side cross sectional view of a multilayer laminate composition according to the disclosure including a structural first layer and a heat-sealable second layer.

FIG. 2 is a side cross sectional view of a multilayer laminate composition according to the disclosure, which further includes a gas and/or moisture barrier layer interposed between the first and second layers.

FIG. 3 illustrates an article packaged using a heat-sealed multilayer laminate composition according to the disclosure.

FIG. 4 illustrates monomer units for representative second polymers incorporated into the heat-sealable second layer.

### DETAILED DESCRIPTION

The disclosure relates to multilayer laminate compositions including opposing first and second polymeric layers, typically with an intervening gas and/or moisture barrier layer. The first polymeric layer incudes a first polymer, which can be selected based on desired mechanical and/or chemical properties. The second polymeric layer is a heat-sealable analog of the first polymeric layer, and it can include a blend of the first polymer along with a second polymer having a lower melting temperature, or a second polymer that includes monomer units of the first polymer copolymerized with a second (different) monomer to provide a lower melting temperature for the second polymer relative to the first polymer. The improved heat-sealing properties of the second polymeric layer permits convenient packaging of items using the multilayer laminate composition. The common polymeric components between the first and second polymeric layers facilitates recycling and reuse of the multilayer laminate composition because of its substantially unimaterial nature.

The disclosed multilayer laminate compositions provide several advantages over conventional MLPs. The multilayer laminate compositions can be recycled via mechanical recycling techniques (e.g., melt-processing multilayer materials into new thermoplastic materials for any desired end use) and/or via chemical recycling techniques (e.g., depolymerizing multilayer materials into component monomers materials for any desired polymeric or other end use). The multilayer laminate compositions can provide super barrier structures, for example with composting properties (e.g., biodegradability in soil, industry, and/or marine environments) that are also repulpable. The multilayer laminate compositions are suitable for both rigid and flexible packaging by varying the selection of laminate layers. The multilayer laminate compositions can provide a carbon-neutral approach when the layer component materials used are renewable, biobased, and abundant; thus making the proposed super barrier structures carbon neutral. The multilayer laminate compositions are readily scalable for mass production because the materials are low cost and the processes are industrially viable. The multilayer laminate compositions also provide super barrier structures that can be metal-free, recyclable/repulpable, and/or be universally compostability. The multilayer laminate compositions enable a shift away from the existing environmentally harmful single-use plastics, non-recyclable MLPs, non-recyclable metalized barrier materials, and PFAS use from packaging.

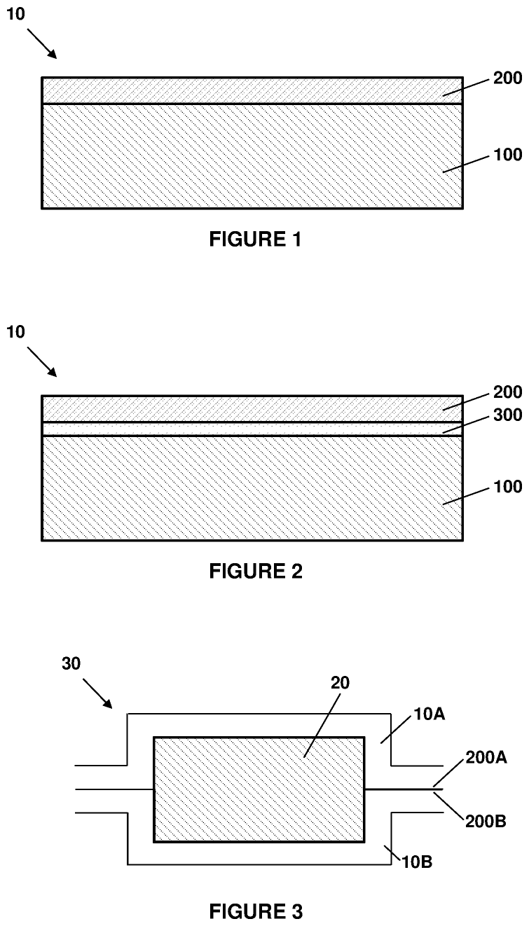

FIG. 1 is a side cross sectional view of a multilayer laminate composition 10 according to the disclosure including a structural first layer 100 and a heat-sealable second layer 200. FIG. 2 is a side cross sectional view of a multilayer laminate composition according to the disclosure 100, which further includes a gas and/or moisture barrier layer 300 interposed between the first and second layers 100, 200. The first polymeric layer 100 incudes a first polymer, which can be selected to provide desired structural, mechanical, and/or chemical properties to the overall composition 10. In embodiments, the first polymer is present in the first layer in an amount of at least 95 wt. % (or at least 98 wt. % or 99 wt. %) relative to the first layer 100. FIG. 3 illustrates a packaged article 30 according to the disclosure in which an item 20 to be packaged is partially or fully enclosed by one or more multilayer laminate compositions, for example two multilayer laminate compositions 10A, 10B as illustrated. The compositions 10A, 10B are oriented so that their second layers 200A, 200B are facing each other and facing the packaged item 20. Application of heat and pressure to the regions where the second layers 200A, 200B are in contact forms the heat seal and encloses the packaged item 20.

The second polymeric layer 200 is a heat-sealable analog of the first polymeric layer 100, and it includes at least one of the first polymer or a polymer containing one or more monomer units of the first polymer. For example, the second layer 200 can include a blend of the first polymer along with a second polymer having a lower melting temperature than that of the first polymer. In such cases, the second layer can include first polymer in an amount of 80-98 wt. %, such as at least 90, 93, or 95 wt. % and/or up to 95, 97, or 98 wt. %, relative to the second layer. Likewise, the second layer can include second polymer in an amount of 2-20 wt. %, such as at least 2, 3, 5, 7, or 10 wt. % and/or up to 5, 7, 12, 15, or 20 wt. %, relative to the second layer. In embodiments, the first polymer and the second polymer are present in the second layer in an amount of at least 95 wt. % (or 98 wt. % or 99 wt. %) relative to the second layer.

Similarly, the second layer 200 can include a second polymer that includes monomer units of the first polymer copolymerized with a second (different) monomer to provide a lower melting temperature for the second polymer relative to the first polymer. In such cases, the second polymer can include monomer units of the first polymer in an amount of 80-98 wt. %, such as at least 90, 93, or 95 wt. % and/or up to 95, 97, or 98 wt. %, relative to the relative to the second polymer. Likewise, the second polymer can include second monomer units (different from the one or more first monomer units) in an amount of 2-20 wt. %, such as at least 2, 3, 5, 7, or 10 wt. % and/or up to 5, 7, 12, 15, or 20 wt. %, relative to the second polymer. In embodiments, the second polymer is present in the second layer in an amount of at least 80, 85, 90, 95, 98, or 99 wt. % relative to the second layer.

In some embodiments, both of these features of the second layer can be combined: For example, the second layer can include a blend of (i) the first polymer, and (ii) a second polymer that includes monomer units of the first polymer copolymerized with a second (different) monomer to provide a lower melting temperature for the second polymer relative to the first polymer. In some cases, a low-melting second polymer can be prepared by branching only, such as in LDPE

The multilayer laminate composition 10 is particularly well suited to both chemical and mechanical recycling processes, because the multilayer structure as a whole contains a substantial majority of a single type of polymeric material or polymers with the same monomer(s). In embodiments, the first polymer can be present in the multilayer laminate composition, for example considering its combined amount in the first and second layers 100, 200, in an amount of at least 90 wt. %. For example, the first polymer can be present in an amount of at least 90, 92, 95, 98, or 99 wt. % and/or up to 95, 98, 99, 99.5 wt. % relative to the multilayer laminate composition as a whole (e.g., combined weight of first layer, second layer, and barrier layer when present). In embodiments, the one or more first monomer units can be present in the multilayer laminate composition in an amount of at least 90 wt. %, for example considering their combined amount in the first and second layers 100, 200 among the polymers therein. For example, the monomers of the first polymer can be present in an amount of at least 90, 92, 95, 98, or 99 wt. % and/or up to 95, 98, 99, 99.5 wt. % relative to the multilayer laminate composition as a whole (e.g., combined weight of first layer, second layer, and barrier layer when present).

The first and second polymers are generally thermoplastic materials. The first polymer and the second polymer can be independently selected from polyesters, polyolefins, and polyamides. Suitably, the first and second polymers are selected within the same class/type of polymer (e.g., both polyesters, both polyolefins, both polyamides, etc.). The polyolefins can include polypropylene homo- and co-polymers, polyethylene of various densities and homo- and co-polymers, etc. The polyesters can include polyethylene terephthalate, polyethylene adipate, polyethylene succinate, polybutylene terephthalate, polybutylene adipate, polybutylene succinate, polycaprolactone, polyhdyroxyalkanoates, and polylactic acid. Polyesters can also be chosen where some on-demand cleavable groups are incorporated such as intermittent carbon-carbon double bonds, intermittent ether linkages, acetal linkages, and so on. In some embodiments, the first and second polymers can be the same type of polymer, but with different melting temperatures (e.g., due to different molecular weights) such that the second polymer still has a lower melting temperature than that of the first polymer to improve heat sealing properties of the second layer. For example, the first and second polymers can both be PET polyesters, with the second PET having a lower melting temperature (e.g., also a lower number-, weight-, or volume-average molecular weight) than the first PET. The lower melting temperature of the second polymer relative to the first polymer can be obtained in a variety of ways, such as by reducing crystallinity of the second polymer relative to the first polymer. For example, reduced crystallinity can be obtained by selecting a copolymer such as LLDPE compared to homopolymer HDPE, selecting a branched second polymer as is the case with LDPE compared to a linear first polymer such as HDPE. The melting temperature of a polymer can be controlled by adjusting or selecting tacticity, for example where atactic polypropylene has lower melting temperature than iso-/syndiotactic polypropylene. Similar principles of introducing comonomers, branching, and/or adjusting tacticity can be applied to polymers other than polyolefins, for example including aliphatic and semi-aromatic polyesters.

In some embodiments, in particular for cases where the first polymer and/or the second polymer are crystalline or semicrystalline polymers, the second polymer can be preferentially selected such that it is at least partially co-crystallizable with the first polymer. More specifically, the second polymer can be selected so that it exhibits isodimorphic crystallization and/or isomorphism with the first polymer. When the second polymer co-crystallizes with the first polymer, in the second layer when the two polymers are melt blended and formed into a layer or film, the co-crystallized state of the two polymers improves compatibility and adhesion within the film (e.g., within a single second layer) and between adjacent film surfaces to be heat sealed (e.g., two adjacent second layer surfaces). The co-crystallized can still exhibit a phase separated structure with discrete first and second polymer domains in the second layer. Nonetheless, the improved adhesion resulting from co-crystallization improves the strength of a corresponding heat seal once formed. Polymer systems exhibiting co-crystallizable behavior are known in the art. Representative polymer systems exhibiting co-crystallizable behavior that are useful for improving heat seal strength in the disclosed compositions include: (1) aliphatic polyolefin systems, such as where a branched LDPE (i.e., low Tm second polymer) co-crystallizes with linear HDPE (i.e., high Tm first polymer); (2) aliphatic copolymer or copolyester systems, such as where an aliphatic copolyester (high Tm first polymer) co-crystallizes with an aliphatic random copolyester (low Tm second polymer); and (3) aliphatic-aromatic copolyester or copolymer systems, such as where an aliphatic aromatic copolyesters (high Tm first polymer) co-crystallizes with an aliphatic random copolyester (low Tm second polymer produced by adding a second aliphatic or aromatic monomer to the first polymer). In the case of semicrystalline polymers, the lower Tm polymer can stereo complexate with the higher Tm polymer. For example, PLA (enriched with L enantiomer where L and D ratio range between 2:1 to 10:1) can stereo complex with PLLA (L enantiomer polymer).

The second polymer has a lower melting temperature (Tₘ) than that of the first polymer so that the second polymer can promote or permit heat sealing between two adjoining surfaces of the second layer. This can include two separate multilayer laminate compositions 10 that are in contact at their respective second layer 200 surfaces when heat sealed together; it can also include a single multilayer laminate composition 10 (e.g., folded upon itself) in which two separate regions or surfaces of the second layer 200 are in contact when heat sealed together. More specifically, the first polymer can be characterized by a first melting temperature (T_{m,1}), and the second polymer can be characterized by a second melting temperature (T_{m,2}). Suitably, a difference between the melting temperatures of the first and second polymer (T_{m,1}−T_{m,2}) is at least 10° C., for example at least 10, 15, 20, 25, 30, 40, 50, 70, or 100° C. and/or up to 20, 30, 40, 50, 60, 70, 80, 100, 120, 150, or 200° C. In cases where the first polymer is polyethylene terephthalate or other polyester, a common temperature difference (T_{m,1}−T_{m,2}) is in a range of 30-80° C. In cases where the first polymer is a polyolefin, a common temperature difference (T_{m,1}−T_{m,2}) is in a range of 10-40° C. or 10-60° C.

Alternatively or additionally, the first and second polymers can be characterized by their individual melting temperatures. For example, the first polymer can have a first melting temperature (T_{m,1}) of at least 100° C. or 130° C., such as at least 100, 130, 150, 180, 200, 220, or 250° C. and/or up to 175, 200, 225, 250, 270, 300° C. Similarly, the second polymer can have a second melting temperature (T_{m,2}) of up to 225° C., such as at least 50, 100, 120, 150, 180, or 200° C. and/or up to 100, 120, 140, 160, 175, 200, 225° C.

As noted above, a melting temperature difference between the first and second polymers promote heat sealing between adjoining second layers. A heat seal is generally formed when two adjoining second layers are heated under an applied force or pressure, such as about 2-5 bar, for a sufficient dwell or contact time, such as about 0.1-10 sec. The dwell time is inversely proportional to the heat sealing temperature and pressure. The heat sealing temperature is generally lower than the first melting temperature (T_{m,1}) of the first polymer, for example being at least 5, 10, 15, 20, 25, 30° C. lower than the first melting temperature (T_{m,1}). The heat sealing temperature can be at least at least 5, 10, 15, 20, 25, 30° C. and/or up to 10, 15, 20, 25, 30, 40, or 80° C. higher than a first glass transition temperature (T_{g,1}) of the first polymer, which chain mobility during heat sealing such that second polymer chains can diffuse into/through first polymer chains. The heat sealing temperature should be high enough to promote mobility of the second polymer such that the second polymer in the two contacting second layers can sufficient migrate and/or mix to form the seal. Suitably, the sealing temperature can be at least 5, 10, 15, 20, 25, 30° C. and/or up to 10, 15, 20, 25, 30, or 40° C. higher than the second melting temperature (T_{m,2}) of the second polymer. This is particularly the case when the second polymer is crystalline or semi-crystalline, but is also applicable when the second polymer is amorphous. When the second polymer is amorphous, however, a lower heat sealing temperature is possible, for example a sealing temperature can be at least at least 5, 10, 15, 20, 25, 30° C. and/or up to 10, 15, 20, 25, 30, 40, 60, or 80° C. higher than a second glass transition temperature (T_{g,2}) of the second polymer.

A typical heat seal strength between two surfaces of the heat-sealable second layer can be at least 5 MPa, for example at least 5, 10, 15, 20, or 30 MPa and/or up to 10, 20, 30, 40, 50, or 60 MPa. Suitable methods for measuring seal strength are known in the art and are illustrated below in the examples. As noted above, this can represent two separate surfaces from the same or different multilayer laminate composition that are heat-sealed together.

The relative and absolute thicknesses of the first layer 100 and the second layer 200 are not particularly limited, and they can be suitably selected depending on the degree of flexibility, degree of mechanical strength, barrier properties, etc. desired for a given application. In embodiments, the first layer 100 can have a thickness in a range of 5 μm to 1000 μm, such as at least 5, 10, 20, 30, 40, 50, 60, 80, 100, or 200 μm and/or up to 15, 25, 50, 75, 100, 200, 300, 500, or 1000 μm. In embodiments, the second layer 200 can have a thickness in a range of 0.5 μm to 100 μm, such as at least 0.5, 1, 2, 3, 4, 5, 6, 8, 10, or 20 μm and/or up to 1.5, 2.5, 5, 7.5, 10, 15, 20, 30, 50, or 100 μm. In embodiments, a ratio of the first layer 100 thickness:the second layer 200 thickness is in a range of 1:1 to 100:1, such as at least 1:1, 2:1, 3:1, 4:1, 5:1, 6:1, 8:1, 10:1, or 20:1 and/or up to 2:1, 5:1, 10:1, 20:1, 30:1, 40:1, 50:1, or 100:1. This ratio being above 1:1 represents a first layer 100 that is thicker than the second layer 200.

As described above, the multilayer laminate composition 10 can include a barrier layer 300 between the first and second layers 100, 200. Typically, the barrier layer 300 is in direct contact with one or both of the first layer 100 and the second layer 200 on opposing sides of the barrier layer 300. In some embodiments, the barrier layer 300 can be formed from or otherwise materials like inorganic oxides (e.g., silicon oxide (SiOx) or silicon dioxide/silica (SiO₂), or alumina (Al₂O₃)), and organic materials (e.g., liquid crystalline polymers, polyglycolic acid, melamine, and reversibly or irreversibly crosslinked polymers (e.g., a complex of polyacrylic acid-polyethylene imine ionic network)), either with and without fillers such as modified or unmodified nanoclay, modified or unmodified cellulose nanocrystals, modified or unmodified cellulose nanofibers or nanofibrils, and modified or unmodified graphene oxides. Suitably, the barrier layer is a non-metallic gas and/or moisture barrier layer, having low water- and/or oxygen-permeability. A non-metallic barrier layer as used herein can include layers without metals in metallic or alloyed form, but possibly in various inorganic oxides such as alumina, etc. In other cases, a non-metallic barrier layer as used herein can include layers without metals in any form, whether metallic, elemental, alloyed, present in inorganic compounds, etc. In embodiments, the barrier layer 300 can have a thickness in a range of 5 nm to 5000 nm, for example at least 5, 10, 20, 30, 40, 50, 60, 80, 100, or 200 nm and/or up to 15, 25, 50, 75, 100, 150, 200, 300, 500, 1000, or 5000 nm.

### EXAMPLES

The following examples illustrate the disclosed materials, articles, and methods, but are not intended to limit the scope of any claims thereto.

### Example 1: Multilayer Laminate Super Barrier Compositions

Example 1 provides illustrative compositions and structures for recyclable and/or biodegradable, high gas and/or moisture barrier, multilayer laminate compositions according to the disclosure.

Recyclable Unimaterial Barrier Compositions: Illustrative recyclable multilayer laminate compositions can incorporate a silicon oxide barrier layer coated onto a PET film as a structural first layer/first polymer, which is then laminated or otherwise attached to a thermally heat-sealable polyester second layer (that can also be PET) to make high barrier structures. Such films are optically clear and can be microwaved. The incorporation of a thin (˜30 nm) layer of an inorganic oxide such as silicon oxide via vapor deposition can be used to impart PET with excellent barrier properties. Currently, silicon oxide-coated PET films are used with nylon and PE for the packaging of cheese, processed meat, condiments, and other applications. The thin silica or other inorganic oxide barrier should not limit otherwise adversely affect the chemical or mechanical recycling of the MLPs, as the barrier will account for only about 0.08% by mass in a representative 35-micron thick multilayer laminate film. In addition, silica and other inorganic particles can be used in the fabrication of films to adjust their surface roughness, etc. In some alternative embodiments, other polyesters such as PBT, PBST, etc. can be used as the first polymer constituting the first layer and the majority of the second layer in place of PET.

Recyclable and Biodegradable Unimaterial Barrier Compositions: Illustrative recyclable multilayer laminate compositions can incorporate a silicon oxide barrier layer coated onto a biodegradable polyester film (e.g., PCL, PLA, PHAs, etc.) as a structural first layer/first polymer, which is then laminated or otherwise attached to a thermally heat-sealable biodegradable polyester second layer (that can also be PCL, PLA, PHAs with a lower melting temperature) to make high barrier structures. Such films are optically clear and can be microwaved. The incorporation of a thin (˜30 nm) layer of an inorganic oxide such as silicon oxide via vapor deposition can be used to impart the biodegradable polyester with excellent barrier properties. The thin silica or other inorganic oxide barrier should not limit otherwise adversely affect the chemical or mechanical recycling of the MLPs, as the barrier will account for only about 0.08% by mass in a representative 35-micron thick multilayer laminate film. In addition, silica and other inorganic particles can be used in the fabrication of films to adjust their surface roughness, etc.

Table 1 below provides some illustrative components, structures, and properties of multilayer laminate compositions according to the disclosure. Composition percent values in Table 1 are wt. % values.

TABLE 1
Recyclable Multilayer Laminate Compositions with
High Gas and/or Moisture Barrier Properties

| | | | |
|---|---|---|---|
| Structure | Material | Thickness | Function |

Embodiment 1 - Recyclable Polyester

| | | | |
|---|---|---|---|
| First Layer | 100% PET | 10-100 μm or | Base/structural |
| | | about 50 μm | integrity |
| Barrier Layer | Silicon oxide | 5-50 nm or | Gas and/or |
| | | about 10 nm | moisture |
| | | | barrier |
| Second Layer | 95-97% PET | 2-20 μm or | Heat-sealable |
| | 3-5% non-PET | about 10 μm | layer |
| | polyester | | |
| Overall Multilayer | At least about | 12-120 μm or | |
| Laminate | 98, 99, 99.5, | about 60 μm | |
| | or 99.9% PET | | |

Embodiment 2 - Recyclable Polyester

| | | | |
|---|---|---|---|
| First Layer | 100% PET | 10-100 μm or | Base/structural |
| | | about 50 μm | integrity |
| Barrier Layer | Silicon oxide | 5-50 nm or | Gas and/or |
| | | about 10 nm | moisture |
| | | | barrier |
| Second Layer | 95-97% PET | 2-20 μm or | Heat-sealable |
| | 3-5% low-Tm | about 10 μm | layer |
| | branched or | | |
| | linear PET | | |
| Overall Multilayer | At least about | 12-120 μm or | |
| Laminate | 98, 99, 99.5, | about 60 μm | |
| | or 99.9% PET | | |

Embodiment 3 - Recyclable and Biodegradable Polyester

| | | | |
|---|---|---|---|
| First Layer | 100% PLA | 10-100 μm or | Base/structural |
| | | about 50 μm | integrity |
| Barrier Layer | Silicon oxide | 5-50 nm or | Gas and/or |
| | | about 10 nm | moisture |
| | | | barrier |
| Second Layer | 95-97% PLA | 2-20 μm or | Heat-sealable |
| | 3-5% low-Tm | about 10 μm | layer |
| | PLA or PLA | | |
| | copolymer | | |
| Overall Multilayer | At least about | 12-120 μm or | |
| Laminate | 98, 99, 99.5, | about 60 μm | |
| | or 99.9% PLA | | |

Embodiment 4 - Recyclable Polyolefin

| | | | |
|---|---|---|---|
| First Layer | 100% HDPE | 10-100 μm or | Base/structural |
| | | about 50 μm | integrity |
| Barrier Layer | Silicon oxide | 5-50 nm or | Gas and/or |
| | | about 10 nm | moisture |
| | | | barrier |
| Second Layer | 95-97% HDPE | 2-20 μm or | Heat-sealable |
| | 3-5% LLDPE | about 10 μm | layer |
| Overall Multilayer | At least about | 12-120 μm or | |
| Laminate | 98, 99, 99.5, | about 60 μm | |
| | or 99.9% HDPE | | |

Embodiment 5 - Recyclable Polyolefin

| | | | |
|---|---|---|---|
| First Layer | 100% PP | 10-100 μm or | Base/structural |
| | | about 50 μm | integrity |
| Barrier Layer | Silicon oxide | 5-50 nm or | Gas and/or |
| | | about 10 nm | moisture |
| | | | barrier |
| Second Layer | 95-97% PP | 2-20 μm or | Heat-sealable |
| | 3-5% LLDPE | about 10 μm | layer |
| Overall Multilayer | At least about | 12-120 μm or | |
| Laminate | 98, 99, 99.5, | about 60 μm | |
| | or 99.9% PP | | |

### Example 2: Heat-Sealable Second Layer Compositions

Example 2 illustrates a series of polymer mixtures that were formed into films and evaluated for their heat sealing properties as a heat sealing second layer in the multilayer laminate compositions according to the disclosure. As described above, the second layer includes a higher-melting first polymer as a primary component and a comparatively lower melting second polymer as a secondary component. The first polymer in this example was a recycled PET material, and the second polymer was selected from various low-melting PET polymers and copolymers.

Recycled poly(ethylene terephthalate) (rPET) was used as the first polymer. The rPET was obtained from plastic juice bottles-clear (32 oz; Uline (Wisconsin, USA)). The bottles were cut into small pieces and milled into small flakes (Average size 2-3 mm) using a Single Speed Cutting Mill (E3300, Eberbach, Michigan, USA).

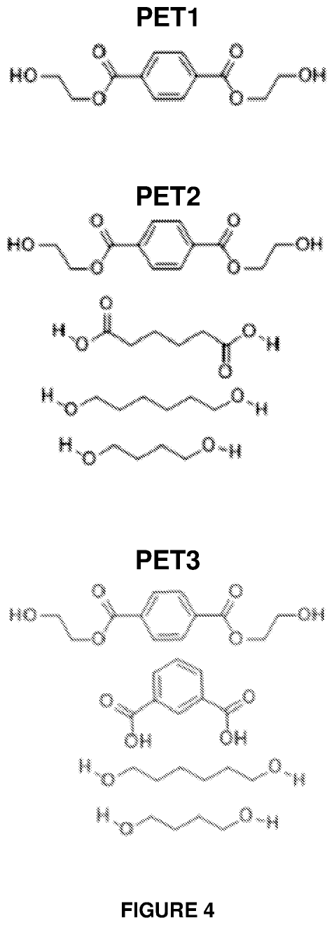

FIG. 4 illustrates the monomers used to polymerize and form corresponding low-melting PET polymers and copolymers denoted as PET1, PET2, and PET3. All monomers were purchased from Sigma Aldrich (USA). PET1 was a PET polymer containing only ethylene and terephthalic monomer units as in the rPET, but with a lower molecular weight and melting temperature (Tₘ˜224° C.) as compared to the rPET (Tₘ˜240° C.). PET2 (Tₘ˜160° C.) was a PET copolymer including hexanedioic, hexanediol, and butanediol segments in addition to the ethylene and terephthalic monomer units. PET3 (Tₘ˜171° C.) was a PET copolymer including hexanediol and butanediol segments in addition to the ethylene and terephthalic monomer units.

The first and second polymers were melt compounded as follows. The rPET was dried in an oven at 130° C. for 12 hours before processing to decrease the moisture content and avoid any hygroscopic reaction. The rPET was mixed manually in a sealed plastic bag with either 5 or 10 wt. % PET1, PET2, or PET3 (i.e., with the balance being rPET). The samples were prepared in twin-screws micro-extruder DSM XPLORE 15cc (Netherlands) at 280° C., 100 rpm, and a 2-minute residence time.

Then, the molten material was injected to form the tensile and impact testing bars according to ASTM 256 and ASTM D638 using a DSM MICRO injector at a 30° C. mold temperature and back-pressure of 0.6 MPa. The tensile bars were kept for at least 40 h before testing. The tensile test was analyzed using an Instron model 5565 tensile testing apparatus (MA, USA) according to ASTM D638 and was examined at a 10 mm/min rate.

The melt-compounded polymer mixtures were also tested for their heat sealing ability. Some samples were sealed on the same tensile-tested samples, and others were tested on films prepared by compression molding. The thermal sealing of the samples was measured by using Sencorp Certek Laboratory heat sealers. All the sealing experiments were performed at 150 or 180° C. with a 10 second dwell time at a constant pressure of 35 psi.

Table 2 below summarizes the tensile and heat sealing properties for neat rPET, which corresponds to a generally non-heat sealable material useable as the first polymer/first layer, and for lower melting blends with rPET, which correspond to a heat sealable material useable as the polymer mixture for the second layer. Composition percent values in Table 2 are wt. % values, and parenthetical values indicate the standard deviation. The results indicate that relatively small amounts of the second polymer can transform the mixture into a heat sealable material, while still providing good tensile properties and a unimaterial composition that is nearly 100% PET material to facilitate recycling.

TABLE 2
Tensile and Sealing Properties of rPET and Blends Thereof

| | Tensile | Tensile | Elongation | Elongation | | |
|---|---|---|---|---|---|---|
| | strength | modulus | at Yield | at break | Sealing at | Sealing at |
| Material | (MPa) | (MPa) | (%) | (%) | 150° C. | 180° C. |
| Neat rPET | 46.5 | 4610 | 1.02 | 88.95 | Not | Not |
| | (0.747) | (54.510) | (0.051) | (13.885) | sealed | sealed |
| 95% rPET/ | 53.8 | 2250 | 3.35 | 133.93 | Not | Sealed |
| 5% PET1 | (5.76) | (41.39) | (0.065) | (13.86) | sealed | |
| 90% rPET/ | — | — | — | — | Sealed | Sealed |
| 10% PET1 | | | | | | |
| 95% rPET/ | 56.7 | 1920 | 3.77 | 137.3 | Not | Sealed |
| 5% PET2 | (2.18) | (191.1) | (0.67) | (8.0) | sealed | |
| 90% rPET/ | 41.6 | 2000 | 3.35 | 109.35 | Sealed | Sealed |
| 10% PET2 | (4.26) | (86.05) | (0.02) | (23.7) | | |
| 95% rPET/ | 58.3 | 1920 | 3.95 | 128.57 | Sealed | Sealed |
| 5% PET3 | (12.73) | (263.14) | (1.37) | (24.11) | | |
| 90% rPET/ | 54.7 | 2020 | 3.48 | 135.17 | Sealed | Sealed |
| 10% PET3 | (4.27) | (97.95) | (0.42) | (11.23) | | |

### Example 3: Barrier Properties of Multilayer Laminate Compositions

Example 3 illustrates the water vapor- and oxygen-barrier properties for multilayer laminate compositions according to the disclosure. PET was used as the first polymer and first layer. A blend of 95% PET/5% PCL (w/w) as the first and second polymers, respectively, was used as a heat sealable second layer. A silica layer was deposited onto the PET first layer in some samples to form a gas and/or moisture barrier layer interposed between the first and second layers.

Films formed from the different layers were assembled and tested for their water barrier properties (water vapor transmission and permeation) and oxygen barrier properties (oxygen transmission and permeation). The thickness of the films was around 90-150 μm. (Tₘ of the blend=240-246° C.). The oxygen and water barrier properties were tested according to ASTM F-1249 and D-3985, respectively. The water barrier properties were evaluated at 38° C. and 90% relative humidity (RH). The oxygen barrier properties were evaluated at 23° C. and 50% RH. Table 3 below summarizes the measured barrier properties, and parenthetical values indicate the standard deviation. The results indicate that inclusion of the silica layer substantially improves the water- and oxygen-barrier properties.

TABLE 3
Water- and Oxygen-Barrier Properties

| | Water | Water | Water | Oxygen | Oxygen |
|---|---|---|---|---|---|
| | transmission | transmission | permeation | transmission | permeation |
| | @50% | @100% | @50% | @100% | @100% |
| Material | (g/m² · d) | (g/m² · d) | (g · mm/m² · d) | (cc/m² · d) | (cc · mm/m² · d) |
| PET/PCL | 17.02 | 34.05 | 0.83 | 867 | 43 |
| (second layer | (4.26) | (8.52) | (0.09) | (145) | (44) |
| only) | | | | | |
| PET-PET/PCL | 7.59 | 15.21 | 0.60 | 3877 | 260 |
| (first and second | (1.14) | (2.28) | (0.09) | (145) | (31) |
| layers) | | | | | |
| PET-silica- | 3.01 | 6.03 | 0.30 | 555 | 36.1 |
| PET/PCL | (0.57) | (1.10) | (0.05) | (172) | (11.2) |
| (first, barrier, and | | | | | |
| second layers) | | | | | |

### Example 4: Barrier Properties of Multilayer Laminate Compositions

Example 4 illustrates a series of polymer mixtures that were formed into films and evaluated for their heat sealing properties as a heat sealing second layer in the multilayer laminate compositions according to the disclosure. As described above, the second layer includes a higher-melting first polymer as a primary component and a comparatively lower melting second polymer as a secondary component. The first polymer in this example was either HDPE or a recycled PET material, and the second polymer was either LLDPE or PCL, respectively.

High density polyethylene (HDPE) (grade DOWLEX IP IP-10262), with a density of 0.960 g/cm³, Tₘ=160-170° C., and an MFI of 9 g/10 min at 190° C./2.16 kg was obtained from Dow, USA. Linear low density polyethylene resin (LLDPE) (grade LL 6100.17), with a density of 0.925 g/cm³, Tₘ=121° C., and an MFI of 20 g/10 min at 190° C./2.16 kg was obtained from ExxonMobil, USA. Food grade LNO p pellets, a recycled poly(ethylene terephthalate) (rPET) (Tₘ˜224° C.), were obtained from Phoenix Technologies, USA. Polycaprolactone (Mn=80,000; Tₘ=62° C.) was purchased from Sigma-Aldrich.

The first and second polymers were melt compounded as follows. The rPET was dried overnight in an oven at 130° C. before processing. All formulations were melt compounded in a co-rotating twin-screw extruder (Leistritz, USA). The barrel temperature profile from the hopper to the die of the extruder were set at 250° C. for rPET formulations and 180° C. for and HDPE formulations. The screw speed and feeding rate were set at 100 rpm and 6 kg/h, respectively. The extruded strands were cooled in a water bath, pelletized and kept in an oven for drying at 80° C. overnight before casting. All formulation films were cast using a RANDCASTLE RCP-0625 MULTI-LAYER CAST film extruder (Randcastle Extrusion Systems, Inc., Cedar Grove, NJ, USA). Table 4 provides the extrusion conditions used to produce the films.

TABLE 4
Processing Conditions for the Cast Film Extrusion

| | Temperature | Chiller | Screw | Nip | Winding |
|---|---|---|---|---|---|
| | profile (° C.) | temperature | speed | roller | roller |
| Material | (Zone 1 to die) | (° C.) | (rpm) | (rpm) | (rpm) |
| Neat HDPE | 182/182/182/182/182/182/182 | 24 | 17 | 20 | 12 |
| HDPE/5% LLDPE | 182/182/182/182/182/182/182 | 24 | 17 | 20 | 12 |
| HDPE/20% LLDPE | 182/182/182/182/182/182/182 | 24 | 17 | 20 | 12 |
| HDPE/5% LDPE | 182/182/182/182/182/182/182 | 24 | 17 | 20 | 12 |
| HDPE/20% LDPE | 182/182/182/182/182/182/182 | 24 | 17 | 20 | 12 |
| Neat rPET | 270/270/270/270/270/271/260 | 90 | 19 | 20 | 12 |
| rPET/5% PCL | 270/270/270/270/270/271/260 | 90 | 19 | 20 | 12 |
| rPET/20% PCL | 270/270/270/270/270/271/260 | 90 | 19 | 20 | 12 |

The thermal sealing of the samples was measured by using Sencorp Certek Laboratory heat sealers. All the sealing experiments were performed at temperatures between 100 and 160° C. with a 5 second dwell time at a constant pressure of 35 psi. The sealing films were kept for at least 40 h before testing. The tensile test was analyzed using an Instron model 5565 tensile testing apparatus (MA, USA) according to ASTM F88/F88M-09 and was examined at a 12 inch/min rate. Table 5 below summarizes the heat sealing properties for neat rPET (seal strength or tensile strength), which corresponds to a generally non-heat sealable material useable as the first polymer/first layer, and for lower melting blends of rPET/PCL, which correspond to a heat sealable material useable as the polymer mixture for the second layer. Table 6 below summarizes the heat sealing properties for neat HDPE (seal strength or tensile strength), which corresponds to a generally non-heat sealable material useable as the first polymer/first layer, and for lower melting blends of HDPE/LLDPE or HDPE/LDPE, which correspond to a heat sealable material useable as the polymer mixture for the second layer. Composition percent values in Tables 5 and 6 are wt. % values.

TABLE 5
Heat Sealing Properties of rPET with PCL

| | Tensile Strength (MPa) | | |
|---|---|---|---|
| Temperature | Neat rPET | 95% rPET/5% PCL | 80% rPET/20% PCL |
| 100° C. | 2.69 ± 0.24 | 3.44 ± 0.60 | 4.37 ± 0.28 |
| 110° C. | 2.80 ± 0.62 | — | 3.28 ± 0.76 |
| 120° C. | 2.83 ± 0.57 | 3.72 ± 0.81 | 4.87 ± 0.75 |
| 130° C. | 3.64 ± 0.61 | 4.50 ± 1.94 | 5.51 ± 0.94 |

TABLE 6
Heat Sealing Properties of HDPE with LLDPE or LDPE

| | Tensile Strength (MPa) | | | | |
|---|---|---|---|---|---|
| | | 95% HDPE/ | 80% HDPE/ | 95% HDPE/ | 80% HDPE/ |
| Temperature | Neat HDPE | 5% LLDPE | 20% LLDPE | 5% LDPE | 20%/LDPE |
| 140° C. | 3.24 ± 1.00 | 3.24 ± 1.00 | 7.42 ± 1.02 | 10.07 ± 1.59 | 11.36 ± 2.44 |
| 150° C. | 2.66 ± 0.10 | 2.91 ± 0.60 | 11.45 ± 2.51 | 29.64 ± 5.20 | 32.34 ± 1.27 |
| 160° C. | 2.78 ± 0.14 | 5.56 ± 0.88 | 13.85 ± 2.80 | 34.62 ± 2.89 | 34.40 ± 2.75 |

Because other modifications and changes varied to fit particular operating requirements and environments will be apparent to those skilled in the art, the disclosure is not considered limited to the example chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In case of conflict, the present description, including definitions, will control.

Throughout the specification, where the compositions, processes, kits, or apparatus are described as including components, steps, or materials, it is contemplated that the compositions, processes, or apparatus can also comprise, consist essentially of, or consist of, any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

What is claimed is:

1. A multilayer laminate composition comprising:
a first layer comprising a first polymer; and
a heat-sealable second layer adjacent to the first layer and comprising (i) the first polymer in an amount of 80-98 wt. % relative to the second layer and (ii) a second polymer in an amount of 2-20 wt. % relative to the second layer; and
optionally, a barrier layer interposed between the first layer and the second layer;
wherein:
the second polymer has a lower melting temperature (Tₘ) than that of the first polymer;
optionally, the first polymer and the second polymer are present in an amount of at least 95 wt. % relative to the second layer; and
optionally, the first polymer is present in an amount of at least 95 wt. % relative to the first layer.

2. The multilayer laminate composition of claim 1, wherein the first polymer is present in the multilayer laminate composition in an amount of at least 90 wt. % relative to the multilayer laminate composition.

3. The multilayer laminate composition of claim 1, wherein the first polymer and the second polymer are independently selected from the group consisting of polyesters, polyolefins, and polyamides.

4. The multilayer laminate composition of claim 1, wherein the first polymer and the second polymer are selected from the following combinations:
(i) the first polymer is polyethylene terephthalate (PET), and the second polymer is a polyester other than polyethylene terephthalate;
(ii) the first polymer is a first polyethylene terephthalate (PET), and the second a second polyethylene terephthalate (PET) having a lower melting temperature (Tₘ) than that of the first PET;
(iii) the first polymer is polylactic acid (PLA), and the second polymer is a polyester other than polylactic acid;
(iv) the first polymer is high density polyethylene (HDPE), and the second polymer is low-density polyethylene (LDPE) or linear low-density polyethylene (LLDPE); and
(v) the first polymer is polypropylene (PP), and the second polymer is low-density polyethylene (LDPE) or linear low-density polyethylene (LLDPE).

5. A multilayer laminate composition comprising:
a first layer comprising a first polymer comprising one or more first monomer units; and
a heat-sealable second layer adjacent to the first layer and comprising a second polymer comprising (i) the one or more first monomer units in an amount of 80-98 wt. % relative to the polymer and (ii) second monomer units relative to the second polymer; and
optionally, a barrier layer interposed between the first layer and the second layer;
wherein:
the second polymer has a lower melting temperature (Tₘ) than that of the first polymer;
optionally, the second polymer is present in an amount of at least 95 wt. % relative to the second layer; and
optionally, the first polymer is present in an amount of at least 95 wt. % relative to the first layer.

6. The multilayer laminate composition of claim 5, wherein the one or more first monomer units are present in the multilayer laminate composition in an amount of at least 90 wt. % relative to the multilayer laminate composition.

7. The multilayer laminate composition of claim 5, wherein the first polymer and the second polymer are independently selected from the group consisting of polyesters, polyolefins, and polyamides.

8. The multilayer laminate composition of claim 5, wherein the first polymer and the second polymer are selected from the following combinations:
(i) the one or more first monomer units comprise terephthalic acid/terephthalic ester and ethylene glycol, and the second monomer units comprise at least one diacid/diester different from terephthalic acid/terephthalic ester; and/or
(ii) the one or more first monomer units comprise terephthalic acid/terephthalic ester and ethylene glycol, and the second monomer units comprise at least one diol different from ethylene glycol.

9. The multilayer laminate composition of claim 1, wherein:
the first polymer has a first melting temperature (T_{m,1}) of at least 130° C.; and/or
the second polymer has a second melting temperature (T_{m,2}) of up to 225° C.

10. The multilayer laminate composition of claim 1, wherein:
the first polymer has a first melting temperature (T_{m,1});
the second polymer has a second melting temperature (T_{m,2}); and
a temperature difference (T_{m,1}−T_{m,2}) is at least 10° C.

11. The multilayer laminate composition of claim 10, wherein:
(i) the first polymer is polyethylene terephthalate, and
(ii) the temperature difference (T_{m,1}−T_{m,2}) is in a range of 30-80° C.

12. The multilayer laminate composition of claim 10, wherein:
(i) the first polymer is a polyolefin, and
(ii) the temperature difference (T_{m,1}−T_{m,2}) is in a range of 10-40° C.

13. The multilayer laminate composition of claim 1, wherein:
the first layer has a thickness in a range of 5 μm to 1000 μm;
the second layer has a thickness in a range of 0.5 μm to 100 μm; and/or
a ratio of the first layer thickness:the second layer thickness is in a range of 1:1 to 100:1.

14. The multilayer laminate composition of claim 1, wherein the second polymer is co-crystallizable with the first polymer.

15. The multilayer laminate composition of claim 1, wherein the barrier layer is absent.

16. The multilayer laminate composition of claim 1, wherein the barrier layer is present.

17. The multilayer laminate composition of claim 16, wherein the barrier layer comprises a material selected from the group consisting of inorganic oxides, liquid crystalline polymers, melamine, and reversibly or irreversibly crosslinked polymers.

18. The multilayer laminate composition of claim 16, wherein the barrier layer is a non-metallic gas and/or moisture barrier layer.

19. The multilayer laminate composition of claim 16, wherein the barrier layer has a thickness in a range of 5 nm to 5000 nm.

20. The multilayer laminate composition of claim 1, wherein a heat seal strength between two surfaces of the heat-sealable second layer is at least 5 MPa.

21. The multilayer laminate composition of claim 1, wherein the multilayer laminate composition has a recycled polymer content in a range of 0-100 wt. % relative to total polymer content in the multilayer laminate composition.

22. The multilayer laminate composition of claim 1, wherein the first polymer and the second polymer are polyesters that are chemically and mechanically recyclable, compostable, and biodegradable in soil and/or water.

23. A packaged article comprising:
a packaged item; and
at least one multilayer laminate composition of claim 1;
wherein:
the at least one multilayer laminate composition at least partially encloses the packaged item; and
the heat-sealable second layer of the multilayer laminate composition is heat-sealed to a further heat-sealable second layer.

24. The packaged article of claim 23, wherein the packaged item comprises a food item.

25. A method of recycling a polymer, the method comprising:
performing a mechanical recycling process or a chemical recycling process on multilayer laminate composition of claim 1, thereby recovering and forming recycled first polymer or recycled monomers of the first polymer, respectively.
